(19) United States
(12) Patent Application Publication
(10) Pub. No.: US 2014/0132103 A1
(43) Pub. Date: May 15, 2014

(54) MOTOR AND INSPECTION METHOD THEREFOR

(71) Applicant: NIDEC SANKYO CORPORATION, Nagano (JP)

(72) Inventors: Masato GOMYO, Nagano (JP); Yoshimi TAKASU, Nagano (JP)

(73) Assignee: NIDEC SANKYO CORPORATION, Nagano (JP)

(21) Appl. No.: 14/077,692

(22) Filed: Nov. 12, 2013

(30) Foreign Application Priority Data
Nov. 13, 2012 (JP) 2012-249628

(51) Int. Cl. H02K 1/27; G01N 27/04

(52) U.S. Cl. CPC H02K 1/2706; G01N 27/04
USPC 310/156.08; 324/701

(57) ABSTRACT

A motor may include a rotor having a rotation shaft made of metal and a cylindrical permanent magnet fixed to the rotation shaft, and a stator facing a peripheral face of the permanent magnet and is electrically insulated from the rotation shaft. The peripheral face of the permanent magnet facing the stator and the rotation shaft are electrically connected with each other.

### CROSS REFERENCE TO RELATED APPLICATION

The present invention claims priority under 35 U.S.C. §119 to Japanese Application No. 2012-249628 filed Nov. 13, 2012, the entire content of which is incorporated herein by reference.

### FIELD OF THE INVENTION

At least an embodiment of the present invention may relate to a motor including a rotor in which a cylindrical permanent magnet is fixed to a metal rotation shaft and relate to an inspection method for the motor.

### BACKGROUND

A motor includes a rotor in which a cylindrical permanent magnet is fixed to a rotation shaft and a stator which faces a peripheral face of the permanent magnet such as a bond magnet in a radial direction and a rotational force is outputted from a portion of the rotation shaft which is protruded from the stator. When the motor is, for example, used for driving an optical head in a drive apparatus for an optical disk such as a DVD or a Blu-ray Disk, a spiral groove with which a rack on an optical head side is engaged is formed on an outer peripheral face of the portion of the rotation shaft which is protruded from the stator (see Japanese Patent Laid-Open No. Hei 9-219946).

When the rotor is rotated in a state that an external force is applied to the rotation shaft, noise or rotational failure may be occurred by contacting of the permanent magnet with the stator. Especially, in a case that a rack is driven by the spiral groove formed on the rotation shaft like a motor as described in the above-mentioned Patent Literature, an external force (lateral pressure) is applied to the rotation shaft from a side and thus the permanent magnet and the stator may be contacted with each other to easily occur noise or rotational failure. Therefore, in an inspecting step for a motor, it is preferable that the rotor is rotated in a state that an external force is applied to the rotation shaft from a side by assuming a used state of the motor to inspect whether the stator is contacted with the permanent magnet or not.

In order to perform the inspection, it is conceivable that the rotor is rotated in a state that a vibration sensor is attached to the stator or the rotation shaft and contacting of the permanent magnet with the stator is inspected by measuring a vibration waveform when the rotor is rotated. However, a motor may occur vibration other than contacting of the permanent magnet with the stator and thus, a method which measures a vibration waveform requires much labor for analyzing the detection signal and it is difficult to accurately evaluate contacting of the permanent magnet with the stator. Further, it is conceivable that a method may be used in which noise when the rotor is rotated is measured or a method in which the rotation shaft is rotated manually to inspect contacting based on hand feeling at that time. However, also in these methods, working efficiency is low and accurate evaluation is difficult.

### SUMMARY

In view of the problem described above, at least an embodiment of the present invention may advantageously provide a motor in which contact of the permanent magnet with the stator when the rotor is rotated is capable of being efficiently inspected and provide an inspection method for the motor.

According to at least an embodiment of the present invention, there may be provided a motor including a rotor having a rotation shaft made of metal and a cylindrical permanent magnet fixed to the rotation shaft, and a stator which faces a peripheral face of the permanent magnet in a radial direction and is electrically insulated from the rotation shaft. A peripheral face of the permanent magnet which faces the stator and the rotation shaft are electrically connected with each other.

Further, according to at least an embodiment of the present invention, there may be provided an inspection method for a motor including a rotor having a rotation shaft made of metal and a cylindrical permanent magnet fixed to the rotation shaft, and a stator which faces a peripheral face of the permanent magnet in a radial direction and is electrically insulated from the rotation shaft. The inspection method includes previously electrically connecting the peripheral face of the permanent magnet facing the stator with the rotation shaft and, in a state that an external force is applied to the rotation shaft in a direction intersecting an axial line direction of the rotation shaft, inspecting electrical conduction of the rotation shaft with the stator while rotating the rotor and thereby inspecting contact of the permanent magnet with the stator.

In at least an embodiment of the present invention, a peripheral face of the permanent magnet facing the stator and the rotation shaft are electrically connected with each other. Therefore, it is electrically detected whether or not the permanent magnet is contacted with the stator by detecting whether or not the rotation shaft and the stator are electrically connected with each other while rotating the rotor in a state that an external force (lateral pressure) is applied to the rotation shaft in a direction intersecting an axial line direction of the rotation shaft. Accordingly, contact of the permanent magnet with the stator is surely and efficiently inspected in comparison with a method detecting vibration, a method detecting noise, a method inspecting by hand feeling, or the like. In this case, at least an embodiment of the present invention may be applied to an inner rotor type motor, in which an inner peripheral face of the permanent magnet is fixed to the rotation shaft and an outer peripheral face of the permanent magnet faces an inner peripheral face of the stator, and to an outer rotor type motor in which an inner peripheral face of the permanent magnet faces an outer peripheral face of the stator.

In at least an embodiment of the present invention, a larger effect can be attained when a spiral groove is formed on an outer peripheral face of a portion of the rotation shaft which is protruded from the stator. In a case that a spiral groove is formed on an outer peripheral face of the rotation shaft, when a rack is driven through the spiral groove, a large force (lateral pressure) is applied to the rotation shaft from a side and thus the permanent magnet and the stator may be easily contacted with each other. However, according to the embodiment of the present invention, contact of the permanent magnet with the stator is surely and efficiently inspected.

In at least an embodiment of the present invention, the permanent magnet is fixed to the rotation shaft by an insulating adhesive, and the permanent magnet and the rotation shaft are electrically connected with each other through an insulation-broken portion of the insulating adhesive. According to this structure, even when the permanent magnet is fixed to the rotation shaft with an insulating adhesive, the permanent magnet and the rotation shaft are electrically connected with each other.

In at least an embodiment of the present invention, it may be structured that the permanent magnet and the rotation shaft are electrically connected with each other through an electrical conduction member.

In at least an embodiment of the present invention, the permanent magnet is a bond magnet in which magnet particles are compounded in a binder made of polymer material, and a peripheral face on a rotation shaft side of the permanent magnet and a peripheral face on a stator side of the permanent magnet are electrically connected with each other by insulation breakdown of the binder between the magnet particles. According to this structure, even when a bond magnet is used as the permanent magnet, a peripheral face on the rotation shaft side of the permanent magnet and a peripheral face on its stator side are electrically connected with each other. For example, an inner peripheral face of the stator is structured as a cylindrical rotor arrangement opening, an outer peripheral face of the bond magnet formed in a cylindrical shape faces the inner peripheral face of the rotor arrangement opening, and the outer peripheral face of the bond magnet is exposed with the binder which is set in an electrically conductive state by insulation breakdown and thereby contact of the bond magnet with the stator is capable of being inspected through the binder in the electrically conductive state and the insulation-broken portion of the insulating adhesive. More specifically, the stator is structured so that a first bobbin and a second bobbin around which a coil is wound and which are formed in a ring shape are adjacently disposed to each other in a motor axial line direction, an inner stator core and an outer stator core which are formed in a ring shape are superposedly disposed on both sides of the first bobbin and the second bobbin in the motor axial line direction, plural pole teeth of the inner stator core and the outer stator core are exposed on the inner peripheral face of the rotor arrangement opening and are adjacently disposed in a circumferential direction on inner peripheral faces of the first bobbin and the second bobbin, and contact of the outer peripheral face of the bond magnet with the plural pole teeth of the inner stator core and the outer stator core is capable of being inspected.

In at least an embodiment of the present invention, the permanent magnet is a bond magnet in which magnet particles are compounded in a binder made of polymer material, and a peripheral face on a rotation shaft side of the bond magnet and a peripheral face on a stator side of the bond magnet are electrically connected with each other through contact of the magnet particles with each other. In this case, it may be structured that the bond magnet is a bond magnet in which magnet particles are contacted with each other by compression molding to be in an electrically conductive state, and the peripheral face on the stator side of the bond magnet and the rotation shaft are electrically connected with each other by contacting the magnet particles of the bond magnet with each other to be electrically connected. Specifically, an inner peripheral face of the stator is structured as a cylindrical rotor arrangement opening, an outer peripheral face of the bond magnet formed in a cylindrical shape faces the inner peripheral face of the rotor arrangement opening, and the magnet particles are exposed on the outer peripheral face of the bond magnet and thereby contact of the bond magnet with the stator is capable of being inspected through the magnet particles.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1(a), 1(b) and 1(c) are explanatory views showing a motor in accordance with a first embodiment of the present invention.

FIGS. 2(a) and 2(b) are explanatory views showing a bearing structure and the like of the motor in accordance with the first embodiment of the present invention.

FIG. 3 is a half cross-sectional view showing a rotor of the motor in accordance with the first embodiment of the present invention.

### DETAILED DESCRIPTION OF THE PREFERRED EMBODIMENTS

Embodiments of a motor to which the present invention is applied will be described below with reference to the accompanying drawings. In the following description, a side where a rotation shaft 50 is protruded from a stator 40 is referred to as an output side “L1” in a motor axial line direction “L”, and a side opposite to the side where the rotation shaft 50 is protruded from the stator 40 is referred to as an opposite-to-output side “L2”.

### First Embodiment

(Entire Structure)

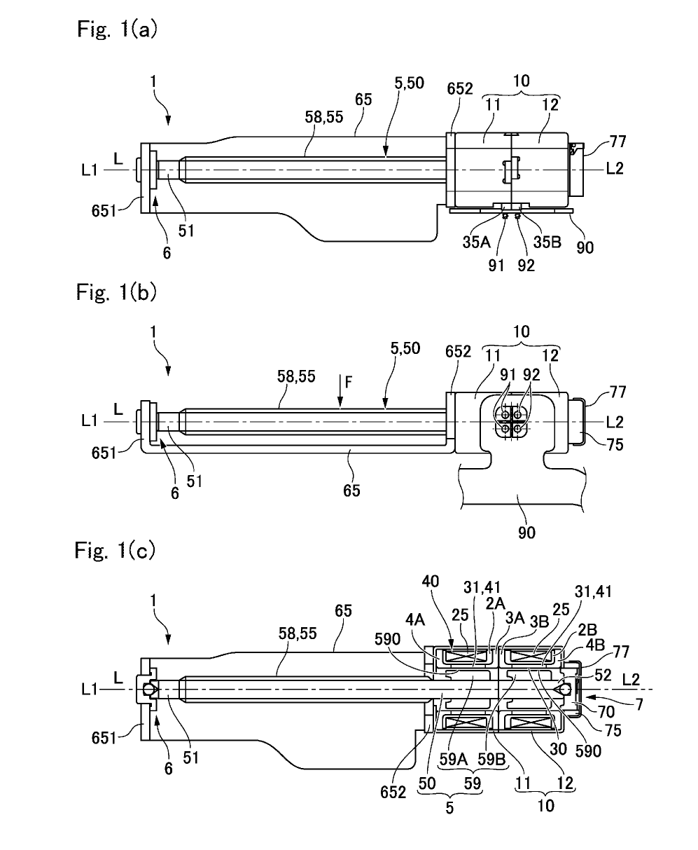

FIGS. 1(a), 1(b) and 1(c) are explanatory views showing a motor in accordance with a first embodiment of the present invention. FIG. 1(a) is a front view showing a motor, FIG. 1(b) is a bottom view showing the motor, and FIG. 1(c) is its cross-sectional view. In FIG. 1(c), an adhesive 8 for fixing a permanent magnet 59 to a rotation shaft 50 is not shown.

A motor 1 shown in FIGS. 1(a), 1(b) and 1(c) is a stepping motor which is used for driving an optical head or the like in a drive apparatus for an optical disk such as a DVD or a Blu-ray Disk. The motor 1 includes a cylindrical or a roughly cylindrical stator 40 and a metal motor case 10 which surrounds the stator 40. The motor case 10 includes a first case member 11 which covers a portion of the stator 40 located on an output side “L1” and a second case member 12 which covers a portion of the stator 40 located on an opposite-to-output side “L2”. The first case member 11 and the second case member 12 are made of metal having electro-conductivity.

In the stator 40, a first ring-shaped bobbin 2A around which a coil 25 is wound and a second ring-shaped bobbin 2B around which a coil 25 is wound are disposed so as to be superposed on each other in a motor axial line direction “L”. In the first bobbin 2A, a ring-shaped inner stator core 3A and a ring-shaped outer stator core 4A are disposed so as to be superposed on each other on both sides in the motor axial line direction “L” and, in the second bobbin 2B, a ring-shaped inner stator core 3B and a ring-shaped outer stator core 4B are disposed so as to be superposed on each other on both sides in the motor axial line direction “L”. Plural pole teeth 31 and 41 of the inner stator cores 3A and 3B and the outer stator cores 4A and 4B are exposed to inner sides with respect to the first bobbin 2A and the second bobbin 2B and are juxtaposed on each other in a circumferential direction. In this manner, a cylindrical or a roughly cylindrical stator 40 provided with a rotor arrangement opening 30 in which the pole teeth 31 and 41 are exposed on its inner side is structured, and a rotor 5 is coaxially disposed on an inner side in a radial direction of the stator 40. In this embodiment, the first bobbin 2A and the second bobbin 2B are made of resin, and the first bobbin 2A and the second bobbin 2B are formed with terminal blocks 35A and 35B to which terminals 91 and 92 are respectively fixed. The terminal blocks 35A and 35B are protruded from cut-out parts formed in the first case member 11 and the second case member 12 to an outer side of the motor case 10, and a flexible wiring board 90 is connected with the terminals 91 and 92.

The inner stator cores 3A and 3B and the outer stator cores 4A and 4B are made of magnetic metal having electro-conductivity. Therefore, the pole teeth 31 and 41 exposed on the inner side in the rotor arrangement opening 30 also have electro-conductivity. Further, the first case member 11 is connected with the inner stator core 3A and the outer stator core 4A by welding or the like, and the second case member 12 is connected with the inner stator core 3B and the outer stator core 4B by welding or the like. Further, the first case member 11 and the second case member 12 are connected with each other by welding or the like. Therefore, the motor case 10 (first case member 11 and second case member 12) are electrically connected with the inner stator cores 3A and 3B and the outer stator cores 4A and 4B. Further, the inner stator cores 3A and 3B and the outer stator cores 4A and 4B may be electrically connected with the motor case 10 (first case member 11 and second case member 12) only by contacting with the motor case 10 (first case member 11 and second case member 12).

In the rotor 5, a rotation shaft 50 is extended in the motor axial line direction “L” and a cylindrical shaped permanent magnet 59 is fixed to the rotation shaft 50 at a position on an opposite-to-output side “L2” of the rotation shaft 50. The rotation shaft 50 is made of metal material such as stainless steel or brass having electro-conductivity. In this embodiment, two permanent magnets 59A and 59B whose outer peripheral faces 590 are cylindrical are provided as the permanent magnet 59 at positions separated from each other in the motor axial line direction “L”. Respective two permanent magnets 59A and 59B are disposed on an inner side of the rotor arrangement opening 30 whose inner peripheral face is cylindrical, and cylindrical outer peripheral faces 590 of the permanent magnets 59A and 59B are faced the pole teeth 31 and 41 of the stator 40 through a predetermined clearance on an inner side in the radial direction. A spiral groove 58 is formed on an outer peripheral face 55 of a rotation shaft 50 on a side protruding from the stator 40 (output side “L1”) to structure a rotation-linear motion conversion mechanism together with a rack formed in an optical head (not shown). The rack is urged toward the spiral groove 58 and thus a lateral pressure is applied to the rotation shaft 50 in a direction perpendicular to the motor axial line direction “L”. Further, in a case that the rack is driven, a force in the motor axial line direction “L” is applied to the spiral groove 58. However, when surface roughness of the spiral groove 58 is large and its frictional resistance is large, for example, as shown by the arrow “F” in FIG. 1(b), a force of component (lateral pressure) in a direction perpendicular to the motor axial line direction “L” is applied to the rotation shaft 50 through the spiral groove 58 by the frictional force. In this embodiment, a diameter of a portion of the rotation shaft 50 to which the permanent magnets 59 are fixed is smaller than that of a portion where the spiral groove 58 is formed.

(Bearing Structure)

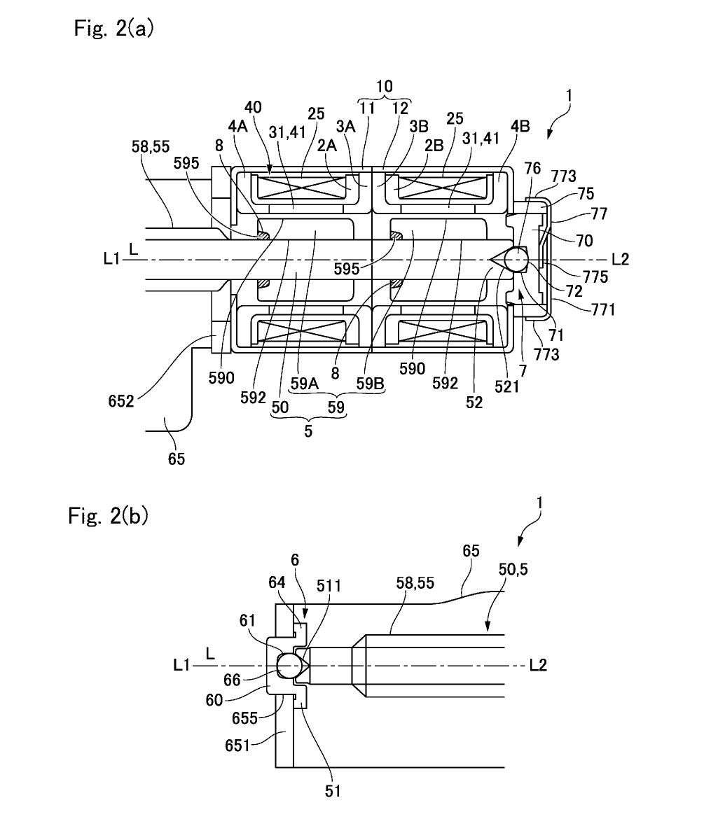

FIGS. 2(a) and 2(b) are explanatory views showing a bearing structure and the like of the motor 1 in accordance with the first embodiment of the present invention. FIG. 2(a) is a cross-sectional view showing a bearing structure on the opposite-to-output side “L2” and FIG. 2(b) is a cross-sectional view showing a bearing structure on the output side “L1”.

As shown in FIGS. 1(a), 1(b) and 1(c) and FIG. 2(a), a connecting plate part 652 of a plate 65 is fixed to an end face on the output side “L1” of the first case member 11 of the motor case 10 by welding or the like. The plate 65 is made of metal having electro-conductivity. A tip end side bent portion 651 of the plate 65 is structured of a bearing mechanism 6 on the output side “L1” which rotatably supports an end part 51 on the output side “L1” of the rotation shaft 50 in the motor axial line direction “L” and the radial direction. On the other hand, a cylindrical shaped bearing holder 75 made of sintered metal is fixed to an end face on the opposite-to-output side “L2” of the second case member 12 of the motor case 10 by welding or the like. A bearing mechanism 7 on the opposite-to-output side “L2” which rotatably supports an end part 52 on the opposite-to-output side “L2” of the rotation shaft 50 in the motor axial line direction “L” and the radial direction is held on an inner side of the bearing holder 75 by utilizing the bearing holder 75. A diameter of the end part 51 on the output side “L1” of the rotation shaft 50 is smaller than that of the portion where the spiral groove 58 is formed. Further, a diameter of the end part 52 on the opposite-to-output side “L2” of the rotation shaft 50 is the same as that of the portion to which the permanent magnet 59 is fixed but is smaller than that of the portion where the spiral groove 58 is formed. In accordance with an embodiment of the present invention, the bearing holder 75 made of resin may be used.

As shown in FIG. 2(a), a disk-shaped bearing member 70 is supported on an inner side of the bearing holder 75 in the bearing mechanism 7 on the opposite-to-output side “L2”, and an end part 52 on the opposite-to-output side “L2” of the rotation shaft 50 is rotatably supported in the motor axial line direction “L” and the radial direction by the bearing member 70 through a ball 76 interposed between the end part 52 and the bearing member 70. In this embodiment, the bearing member 70 is made of resin having insulation property. Therefore, the rotation shaft 50 is rotatably supported by an insulating bearing member 70.

A recessed part 71 is formed in the bearing member 70 so as to be recessed toward the opposite-to-output side “L2” from its end face on the output side “L1” and a portion located on the opposite-to-output side “L2” of a ball 76 is fitted into an inner side of the recessed part 71. In this embodiment, the recessed part 71 is structured of a bottomed recessed part which is provided with a bottom part 72 (receiving part) for rotatably supporting the ball 76 from the opposite-to-output side in the motor axial line direction “L” and the bottom part 72 is formed in a conical surface. An end face of the end part 52 on the opposite-to-output side “L2” of the rotation shaft 50 which faces the bearing member 70 is formed with a recessed part 521 which is recessed toward the output side “L1” and a portion located on the output side “L1” of the ball 76 is disposed on an inner side of the recessed part 521. In this embodiment, an inner peripheral face of the recessed part 521 is formed in a conical surface whose diameter is enlarged toward the opposite-to-output side “L2” (side where the bearing member 70 is located).

The bearing member 70 is structured so as to be movable in the motor axial line direction “L” on an inner side of the bearing holder 75 and the bearing member 70 is urged toward the output side “L1” by a plate spring-shaped urging member 77 which is disposed on the opposite-to-output side “L2” with respect to the bearing member 70. The urging member 77 is provided with an end plate part 771, which is superposed on a face on the opposite-to-output side “L2” of the bearing member 70, and plural side plate parts 773 which are protruded toward the output side “L1” from an outer peripheral edge of the end plate part 771. The side plate parts 773 located at facing positions each other are extended to an end face on the output side “L1” of the bearing holder 75 through a side face of the bearing holder 75 and are engaged with the end face on the output side “L1” of the bearing holder 75 as a hook part and, in this manner, the urging member 77 is fixed to the bearing holder 75. A center portion of the end plate part 771 is cut and bent to form a plate spring part 775 and the plate spring part 775 urges the bearing member 70 toward the output side “L1”. Therefore, the ball 76 is urged toward the output side “L1” (side where the rotation shaft 50 is located) through the bearing member 70 by the plate spring part 775 and, on the output side “L1”, the bearing mechanism 6 (see FIG. 2(b)) is structured so as to rotatably support the end part 51 on the output side “L1” of the rotation shaft 50 in the motor axial line direction “L” and the radial direction. Accordingly, the rotation shaft 50 is urged so that the end part 51 on the output side “L1” is abutted with the bearing mechanism 6 and thus, when the rotation shaft 50 is rotated, rattling of the rotation shaft 50 in the motor axial line direction “L” is prevented.

As shown in FIG. 2(b), a structure similar to the bearing mechanism 7 is adopted in the bearing mechanism 6 which is provided on the output side “L1” in the motor axial line direction “L”. More specifically, a ball 66 is disposed between a bearing member 60 on the output side “L1”, which is held by the tip end side bent portion 651 of the plate 65, and an end part 51 on the output side “L1” of the rotation shaft 50. In this embodiment, an end face on the output side “L1” of the rotation shaft 50 is formed with a recessed part 511 which is recessed toward the opposite-to-output side “L2” and an end face on the opposite-to-output side “L2” of the bearing member 60 is formed with a receiving part 61 which is recessed toward the output side “L1”. The ball 66 is disposed between the recessed part 511 of the rotation shaft 50 and the receiving part 61 of the bearing member 60. The bearing member 60 is provided with a large diameter part 64 abutting with a face on the opposite-to-output side “L2” of the tip end side bent portion 651 in a penetrated state through a hole 655 which is formed in the tip end side bent portion 651 of the plate 65 and thus movement of the bearing member 60 to the output side “L1” is restricted. In this embodiment, the bearing member 60 is made of resin having insulation property. Therefore, the rotation shaft 50 is rotatably supported by an insulating bearing member 60 and thus the rotation shaft 50 and the stator 40 are electrically insulated from each other.

(Detailed Structure of Rotor 5)

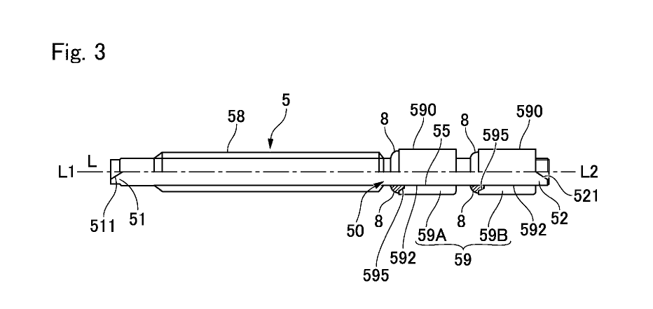

FIG. 3 is a half cross-sectional view showing the rotor 5 of the motor 1 in accordance with the first embodiment of the present invention. In FIGS. 1(a) through FIG. 3, the rotor 5 includes the rotation shaft 50 made of metal and a cylindrical-shaped permanent magnet 59 (permanent magnets 59A and 59B) which is fixed to the rotation shaft 50 at a position on the opposite-to-output side “L2”. In this embodiment, the respective permanent magnets 59A and 59B are fixed to an outer peripheral face 55 of the rotation shaft 50 with an adhesive 8. More specifically, the adhesive 8 is thinly provided between inner peripheral faces 592 of the permanent magnets 59A and 59B and an outer peripheral face 55 of the rotation shaft 50 and is provided on end faces on the output side “L1” of the permanent magnets 59A and 59B and, in this manner, the rotation shaft 50 and the permanent magnet 59 (permanent magnets 59A and 59B) are fixed to each other. In this embodiment, a truncated cone-shaped recessed part 595 is formed on end faces on the output side “L1” of the permanent magnets 59A and 59B and the adhesive 8 is applied to an inner side of the recessed part 595. The adhesive 8 is a UV-curing anaerobic adhesive such as an acrylic-based adhesive and is provided with insulation property.

In this embodiment, the permanent magnet 59 (permanent magnets 59A and 59B) is a bond magnet which is structured so that magnet particles are compounded in a binder made of high polymer material and, in this embodiment, the permanent magnet 59 is a neodymium bond magnet in which neodymium magnet particles are compounded as a magnet particle. Further, the surface of the permanent magnet 59 is not formed with a non-conductive resin coating layer.

In the rotor 5 structured as described above, the outer peripheral face 590 of the permanent magnet 59 (permanent magnets 59A and 59B) and the rotation shaft 50 are electrically connected with each other. More specifically, the permanent magnet 59 and the rotation shaft 50 are electrically connected with each other through an insulation-broken portion of the adhesive 8, and a peripheral face on a rotation shaft 50 side (inner peripheral face 592) of the permanent magnet 59 and a peripheral face on a stator 40 side (outer peripheral face 590) are electrically connected with each other through insulation breakdown of the binder between the magnet particles. Therefore, the outer peripheral face 590 of the permanent magnet 59 (permanent magnets 59A and 59B) and the rotation shaft 50 are electrically connected with each other.

The rotor 5 having the structure as described above may be manufactured by the following method. First, the permanent magnet 59 (permanent magnets 59A and 59B) is fixed to the rotation shaft 50 with an insulating adhesive 8. After that, an electrode is contacted with the entire outer peripheral face 590 of the permanent magnet 59 in the circumferential direction and, in this state, a voltage higher than a withstand voltage of the insulating adhesive 8 and a withstand voltage of the binder used in the permanent magnet 59 is applied between the electrode and the rotation shaft 50. In this embodiment, an AC voltage of about 1000V is applied between the electrode and the rotation shaft 50 for about 1 second. An electric current flowing in this case is about 5 mA. As a result, insulation of at least a part of the insulating adhesive 8 is broken and carbonized and thus the permanent magnet 59 and the rotation shaft 50 are electrically connected with each other through the insulation-broken portion of the adhesive 8. Further, in the permanent magnet 59, insulation of the binder between the magnet particles is partially broken and carbonized and thus, the inner peripheral face 592 and the outer peripheral face 590 of the permanent magnet 59 are electrically connected with each other through the insulation-broken portion of the binder.

For example, even when a resistance value between the outer peripheral face 590 of the permanent magnet 59 and the rotation shaft 50 is infinity before the above-mentioned AC voltage is applied, the resistance value becomes not more than 20 ohm after application of the AC voltage. Therefore, in this embodiment, as described below, inspection for the motor 1 is performed by utilizing that the outer peripheral face 590 of the permanent magnet 59 and the rotation shaft 50 are electrically connected with each other.

(Inspection Method for Motor 1)

In this embodiment, in a case that the motor 1 is used for driving an optical head in a drive apparatus for an optical disk such as a DVD or a Blu-ray Disk and, in this state, assuming that an external force (lateral pressure) is applied to the rotation shaft 50 from a side, inspection is performed so that whether the permanent magnet 59 and the stator 40 are contacted with each other or not when the rotor 5 is rotated.

More specifically, an electric current is supplied to the motor 1 to rotate the rotor 5 in a state that an external force (lateral pressure/see the arrow “F” in FIG. 1(b)) is applied to the rotation shaft 50 by a load member such as a roller in a direction intersecting the motor axial line direction “L” of the rotation shaft 50 and, in this state, it is inspected whether the outer peripheral face 590 of the permanent magnet 59 of the rotor 5 and the pole teeth 31 and 41 of the stator 40 are contacted with each other or not. In this case, the outer peripheral face 590 of the permanent magnet 59 and the rotation shaft 50 are electrically connected with each other. Further, the inner stator cores 3A and 3B and the outer stator cores 4A and 4B which are used in the stator 40 are electrically connected with the motor case 10 and the motor case 10 is electrically connected with the plate 65. Further, the end part 52 on the opposite-to-output side “L2” of the rotation shaft 50 is supported by the stator 40 through the bearing member 70 made of resin and the end part 51 on the output side “L1” of the rotation shaft 50 is supported by the plate 65 through the bearing member 60 made of resin and thus the rotation shaft 50 and the plate 65 are electrically insulated from each other. Therefore, in this embodiment, it is inspected whether or not the outer peripheral face 590 of the permanent magnet 59 of the rotor 5 is contacted with the pole teeth 31 and 41 of the stator 40 by monitoring a resistance value between a portion of the rotation shaft 50 exposed from the motor case 10 and the plate 65.

In other words, in a case that the outer peripheral face 590 of the permanent magnet 59 of the rotor 5 and the pole teeth 31 and 41 of the stator 40 are not contacted with each other, a resistance value between the rotation shaft 50 and the plate 65 is infinity. However, when the outer peripheral face 590 of the permanent magnet 59 of the rotor 5 and the pole teeth 31 and 41 of the stator 40 are contacted with each other, a resistance value between the rotation shaft 50 and the plate 65 becomes 50 ohm or less. Therefore, in a case that the rotor 5 is rotated in a state that an external force is applied to the rotation shaft 50 in a direction intersecting the motor axial line direction “L” of the rotation shaft 50 by a load member such as a roller and, when a resistance value between the rotation shaft 50 and the plate 65 is infinity, it is found that the outer peripheral face 590 of the permanent magnet 59 of the rotor 5 is not contacted with the pole teeth 31 and 41 of the stator 40 and thus the rotor is normally rotated. On the other hand, if a resistance value between the rotation shaft 50 and the plate 65 becomes 50 ohm or less, it is found that a situation is occurred that the outer peripheral face 590 of the permanent magnet 59 of the rotor 5 and the pole teeth 31 and 41 of the stator 40 are contacted with each other. Therefore, a motor 1 in which a situation is occurred that a resistance value between the rotation shaft 50 and the plate 65 becomes 50 ohm or less is determined to be a defective motor whose lateral pressure resistance is low.

(Principal Effects in this Embodiment)

As described above, in the motor 1 in accordance with an embodiment of the present invention, the outer peripheral face 590 of the permanent magnet 59 and the rotation shaft 50 are electrically connected with each other. Specifically, the entire periphery in the axis direction of the cylindrical outer peripheral face 590 of each of the permanent magnets 59A and 59B is electrically connected with the rotation shaft 50. Therefore, it is electrically detected whether or not the permanent magnet 59 is contacted with the pole teeth 31 and 41 of the stator 40 in a state that an external force is applied to the rotation shaft 50 in a direction intersecting the motor axial line direction “L” of the rotation shaft 50 by monitoring whether or not the rotation shaft 50 and the stator 40 (plate 65) are electrically connected with each other while rotating the rotor 5. Accordingly, contact of the permanent magnet 59 with the stator 40 is surely and efficiently inspected in comparison with a method detecting vibration, a method detecting noise, a method inspecting by hand feeling, or the like.

Further, in this embodiment, the spiral groove 58 is formed on the outer peripheral face 55 of a portion of the rotation shaft 50 which is protruded from the stator 40 and thus, when this embodiment is applied, a larger effect can be attained. In other words, in a case that the spiral groove 58 is formed on the outer peripheral face 55 of the rotation shaft 50, when a rack is driven through the spiral groove 58, a large force (see the arrow “F” in FIG. 1(b)) is applied to the rotation shaft 50 from a side and thus the permanent magnet 59 and the stator 40 may be easily contacted with each other. However, according to this embodiment, contact of the permanent magnet 59 with the stator 40 is surely and efficiently inspected. Therefore, a defective product whose performance for a lateral pressure resistance is low can be removed and thus, in the motor 1 having passed the inspection, the rotation shaft 50 is not so displaced that the permanent magnet 59 and the stator 40 are contacted with each other even when a lateral pressure is applied to the rotation shaft 50 for driving an optical head in a drive apparatus for an optical disk such as a DVD or a Blu-ray Disk. Accordingly, even when the motor 1 is used for driving an optical head in a drive apparatus for an optical disk such as a DVD or a Blu-ray Disk, occurrence of noise and rotational failure is effectively avoided.

Further, in this embodiment, the permanent magnet 59 is fixed to the rotation shaft 50 by an insulating adhesive 8 but the permanent magnet 59 and the rotation shaft 50 are electrically connected with each other through the insulation-broken portion of the insulating adhesive 8. Therefore, even when the permanent magnet 59 is fixed to the rotation shaft 50 by using an insulating adhesive 8 instead of using an expensive adhesive having electro-conductivity, the permanent magnet 59 and the rotation shaft 50 are electrically connected with each other. Further, the permanent magnet 59 is a bond magnet which is structured so that magnet particles are mixed in a binder made of high-polymer material, and the inner peripheral face 592 of the permanent magnet 59 (peripheral face on the rotation shaft 50 side) and the outer peripheral face 590 (peripheral face on the stator 40 side) are electrically connected with each other through the insulation breakdown of the binder between the magnet particles. Therefore, even when a bond magnet is used as the permanent magnet 59, the inner peripheral face 592 and the outer peripheral face 590 of the permanent magnet 59 are electrically connected with each other. In addition, application of electro-conductivity to the insulating adhesive 8 and application of electro-conductivity to the permanent magnet 59 made of a bond magnet can be realized by application of a high voltage after the permanent magnet 59 is fixed to the rotation shaft 50 by the insulating adhesive 8. Therefore, application of electro-conductivity to the insulating adhesive 8 and application of electro-conductivity to the permanent magnet 59 made of a bond magnet is easily and surely performed. Further, an adhesive strength of the adhesive 8 is not varied largely after the adhesive 8 is applied with electro-conductivity and, in the permanent magnet 59 made of a bond magnet, the characteristics as a magnet are not varied largely after the magnet is applied with electro-conductivity. Further, since an expensive conductive adhesive is not required to use for the adhesive 8, the cost is not increased largely.

[Modified Example of First Embodiment]

In the first embodiment, the adhesive 8 is applied between the inner peripheral faces 592 of the permanent magnets 59A and 59B and the outer peripheral face 55 of the rotation shaft 50. However, it may be structured that no adhesive 8 is applied or the adhesive 8 is applied extremely thinly between the inner peripheral faces 592 of the permanent magnets 59A and 59B and the outer peripheral face 55 of the rotation shaft 50. In these structures, when the rotation shaft 50 is press-fitted into the permanent magnet 59, the magnet particles of the permanent magnet 59 are directly contacted with the outer peripheral face 55 of the rotation shaft 50. Also in these cases, insulation of the binder of the permanent magnet 59 is partially broken down by applying a high voltage to the permanent magnet 59. As a result, the outer peripheral face 590 on the stator 40 side of the permanent magnet 59 and the rotation shaft 50 are electrically connected with each other. In other words, the insulation of the binder of the permanent magnet 59 is partially broken down so that the outer peripheral face 590 of the permanent magnet 59 and the rotation shaft 50 are electrically connected with each other.

### Second Embodiment

In the first embodiment, an insulation-broken portion of the insulating adhesive 8 is utilized for electrically connecting the permanent magnet 59 with the rotation shaft 50. However, a conductive adhesive may be used as the adhesive 8. For example, the permanent magnet 59 may be fixed to the rotation shaft 50 by using a conductive adhesive containing silver particles or the like. Further, it may be structured that, after the permanent magnet 59 and the rotation shaft 50 are fixed to each other by an insulating adhesive 8, an adhesive having electro-conductivity (electrical conduction member) may be applied so as to extend to both of an end face of the permanent magnet 59 and the rotation shaft 50. Further, since it is sufficient that the outer peripheral face 590 of the permanent magnet 59 is electrically connected with the rotation shaft 50, a sleeve-shaped electrical conduction member which is contacted with the rotation shaft 50 may be coated on the outer peripheral face 590 of the permanent magnet 59.

### Third Embodiment

In the embodiment described above, the permanent magnet 59 is a bond magnet in which neodymium magnet particles are compounded in a binder made of high-polymer material. However, a permanent magnet 59 having electro-conductivity itself may be used. For example, the permanent magnet 59 is a bond magnet in which magnet particles are compounded in a binder made of high-polymer material and an inner peripheral face 592 on the rotation shaft 50 side of the permanent magnet 59 and its outer peripheral face 590 on the stator 40 side are electrically connected with each other by contacting of the magnet particles with each other. More specifically, the permanent magnet 59 is a bond magnet which is manufactured by compression molding and its compounding ratio of the magnet particles is high in comparison with that in a bond magnet manufactured by injection molding. Therefore, the inner peripheral face 592 on the rotation shaft 55 side of the permanent magnet 59 and its outer peripheral face 590 on the stator 40 side are electrically connected with each other through contacting of magnet particles with each other.

In the structure described above, it may be structured that, when the rotation shaft 50 is press-fitted into the permanent magnet 59, the magnet particles of the permanent magnet 59 and the outer peripheral face 55 of the rotation shaft 50 are directly contacted with each other and thus, the permanent magnet 59 and the outer peripheral face 55 of the rotation shaft 50 are electrically connected with each other.

### Other Embodiments

In the embodiment described above, the present invention is applied to an inner rotor type stepping motor in which the inner peripheral face 592 of the permanent magnet 59 is fixed to the rotation shaft 50 and the outer peripheral face 590 of the permanent magnet 59 faces the stator 40. However, at least an embodiment of the present invention may be applied to an outer rotor type stepping motor in which an inner peripheral face of the permanent magnet 59 faces the stator. Further, in the embodiment described above, the present invention is applied to a stepping motor but at least an embodiment the present invention may be applied to a motor other than a stepping motor.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a rotor comprising a rotation shaft made of metal and a cylindrical permanent magnet fixed to the rotation shaft; and
a stator which faces a peripheral face of the permanent magnet in a radial direction and is electrically insulated from the rotation shaft;
wherein the peripheral face of the permanent magnet which faces the stator and the rotation shaft are electrically connected with each other.

2. The motor according to claim 1, wherein a spiral groove is formed on an outer peripheral face of a portion of the rotation shaft which is protruded from the stator.

3. The motor according to claim 2, wherein
the permanent magnet is fixed to the rotation shaft by an insulating adhesive, and
the permanent magnet and the rotation shaft are electrically connected with each other through an insulation-broken portion of the insulating adhesive.

4. The motor according to claim 2, wherein the permanent magnet and the rotation shaft are electrically connected with each other through an electrical conduction member.

5. The motor according to claim 4, wherein the motor is one of an inner rotor type motor, in which an inner peripheral face of the permanent magnet is fixed to the rotation shaft and an outer peripheral face of the permanent magnet faces an inner peripheral face of the stator, and an outer rotor type motor in which an inner peripheral face of the permanent magnet faces an outer peripheral face of the stator.

6. The motor according to claim 1, wherein
the permanent magnet is a bond magnet in which magnet particles are compounded in a binder made of polymer material, and
a peripheral face on a rotation shaft side of the permanent magnet and a peripheral face on a stator side of the permanent magnet are electrically connected with each other by insulation breakdown of the binder between the magnet particles.

7. The motor according to claim 6, wherein
the bond magnet is fixed to the rotation shaft by an insulating adhesive, and
the bond magnet and the rotation shaft are electrically connected through an insulation-broken portion of the insulating adhesive.

8. The motor according to claim 7, wherein
an inner peripheral face of the stator is structured as a cylindrical rotor arrangement opening,
an outer peripheral face of the bond magnet formed in a cylindrical shape faces the inner peripheral face of the rotor arrangement opening, and
the outer peripheral face of the bond magnet is exposed with the binder which is set in an electrically conductive state by insulation breakdown and thereby contact of the bond magnet with the stator is capable of being inspected through the binder in the electrically conductive state and the insulation-broken portion of the insulating adhesive.

9. The motor according to claim 8, wherein
the stator is structured so that a first bobbin and a second bobbin around which a coil is wound and which are formed in a ring shape are adjacently disposed to each other in a motor axial line direction,
an inner stator core and an outer stator core which are formed in a ring shape are superposedly disposed on both sides of the first bobbin and the second bobbin in the motor axial line direction,
plural pole teeth of the inner stator core and the outer stator core are exposed on the inner peripheral face of the rotor arrangement opening and are adjacently disposed in a circumferential direction on inner sides with respect to the first bobbin and the second bobbin, and
contact of the outer peripheral face of the bond magnet with the plural pole teeth of the inner stator core and the outer stator core is capable of being inspected.

10. The motor according to claim 6, wherein the bond magnet and the rotation shaft are electrically connected with each other through an electrical conduction member.

11. The motor according to claim 6, wherein
the rotation shaft is rotatably supported by a bearing member having insulation property, and
a spiral groove is formed on an outer peripheral face of a portion of the rotation shaft which is protruded from the stator.

12. The motor according to claim 1, wherein
the permanent magnet is a bond magnet in which magnet particles are compounded in a binder made of polymer material, and
a peripheral face on a rotation shaft side of the bond magnet and a peripheral face on a stator side of the bond magnet are electrically connected with each other through contact of the magnet particles with each other.

13. The motor according to claim 12, wherein the bond magnet is a bond magnet in which magnet particles are contacted with each other by compression molding to be in an electrically conductive state, and
the peripheral face on the stator side of the bond magnet and the rotation shaft are electrically connected with each other through contact of the magnet particles of the bond magnet with each other to be electrically connected.

14. The motor according to claim 13, wherein
an inner peripheral face of the stator is structured as a cylindrical rotor arrangement opening,
an outer peripheral face of the bond magnet formed in a cylindrical shape faces the inner peripheral face of the rotor arrangement opening, and
the magnet particles are exposed on the outer peripheral face of the bond magnet and thereby contact of the bond magnet with the stator is capable of being inspected through the magnet particles.

15. The motor according to claim 14, wherein
the stator is structured so that a first bobbin and a second bobbin around which a coil is wound and which are formed in a ring shape are adjacently disposed to each other in a motor axial line direction,
an inner stator core and an outer stator core which are formed in a ring shape are superposedly disposed on both sides of the first bobbin and the second bobbin in the motor axial line direction,
plural pole teeth of the inner stator core and the outer stator core are exposed on the inner peripheral face of the rotor arrangement opening and are adjacently disposed in a circumferential direction on inner side with respect to the first bobbin and the second bobbin, and
contact of the outer peripheral face of the bond magnet with the plural pole teeth of the inner stator core and the outer stator core is capable of being inspected.

16. The motor according to claim 12, wherein
the bond magnet is fixed to the rotation shaft by an insulating adhesive, and
the bond magnet and the rotation shaft are electrically connected through an insulation-broken portion of the insulating adhesive.

17. The motor according to claim 12, wherein the bond magnet and the rotation shaft are electrically connected with each other through an electrical conduction member.

18. The motor according to claim 12, wherein
the rotation shaft is rotatably supported by a bearing member having insulation property, and
a spiral groove is formed on an outer peripheral face of a portion of the rotation shaft which is protruded from the stator.

19. An inspection method for a motor including a rotor having a rotation shaft made of metal and a cylindrical permanent magnet fixed to the rotation shaft, and a stator which faces a peripheral face of the permanent magnet in a radial direction and is electrically insulated from the rotation shaft, comprising:
previously electrically connectingconnecting the peripheral face of the permanent magnet facing the stator with the rotation shaft; and
in a state that an external force is applied to the rotation shaft in a direction intersecting an axial line direction of the rotation shaft, inspecting electrical connection of the rotation shaft with the stator while rotating the rotor and thereby inspecting contact of the permanent magnet with the stator.

20. The inspection method for a motor according to claim 19, wherein
the rotation shaft is formed with a spiral groove on an outer peripheral face of a portion which is protruded from the stator, and
when the motor is to be inspected, pressing a load member to the spiral groove so that the external force is applied to the rotation shaft.

21. The inspection method for a motor according to claim 19, wherein
the permanent magnet is a bond magnet in which magnet particles are compounded in a binder made of polymer material,
insulation of the binder is broken down so that the binder between the magnet particles is electrically connected,
the binder is exposed on a peripheral face of the bond magnet facing the stator, and
contact of the bond magnet and the stator is inspected through the binder electrically connected by insulation breakdown.

22. The inspection method for a motor according to claim 19, wherein
the permanent magnet is a bond magnet in which magnet particles are compounded in a binder made of polymer material,
the bond magnet is a bond magnet in which magnet particles are contacted with each other by compression molding to be in an electrically conductive state, and
the magnet particles are exposed on a peripheral face of the bond magnet facing the stator and thereby contact of the bond magnet with the stator is inspected through the magnet particles.

23. The inspection method for a motor according to claim 19, wherein
the bond magnet is fixed to the rotation shaft by an insulating adhesive, and
the bond magnet and the rotation shaft are electrically connected with each other through an insulation-broken portion of the insulating adhesive.
